(19) United States
(12) Patent Application Publication
(10) Pub. No.: US 2003/0236913 A1
(43) Pub. Date: Dec. 25, 2003

(54) Network address translation for internet control message protocol packets

(76) Inventors: Adrian C. Hoban, County Mayo (IE); Mark G. Burkley, Limerick (IE)

Correspondence Address: FISH & RICHARDSON, PC, 12390 EL CAMINO REAL, SAN DIEGO, CA, 92130-2081, US

(21) Appl. No.: 10/183,611

(22) Filed: Jun. 25, 2002

(51) Int. Cl. G06F 15/173; G06F 15/16

(52) U.S. Cl. 709/238; 709/245

(57) ABSTRACT

Network address translation (NAT) for Internet control message protocol (ICMP) packets uses an identifier of the ICMP packet to translate the packets. ICMP packets are identified and the identifier is determined from the ICMP packet header. The identifier is used to create and search entries in a NAT table during translation of the packets.

### BACKGROUND

The following description relates to network address translation (NAT), and more particularly to NAT for Internet control message protocol (ICMP) packets.

Before data is transmitted between hosts in a packet switched network, the data is divided into packets. The packets include headers that are used by a router to process the packets. For example, each packet may include an Internet Protocol (IP) header and a transmission control protocol (TCP) header. The IP header is used to route a packet through the network. The TCP header is used to reassemble packets at their destination.

Hosts may use private IP addresses to route packets between hosts in a private network. However, if a private IP address is not globally-unique (i.e., a publicly registered IP address), then the private IP address is not recognized by hosts outside of the private network. As a result, packets that have a private source IP address and have a destination IP address outside of the private network may be translated to include a globally-unique IP address.

One method of translating an IP address is NAT. NAT provides transparent routing of data packets between a private network and a public network). For example, NAT may translate the packet IP header by replacing a private source IP address of an outbound packet with a globally-unique IP address. NAT may be used to translate IP/TCP packets without difficulty. However, ICMP packets have a different header structure than TCP packets, and, therefore, must be processed differently.

### DESCRIPTION OF DRAWINGS

FIGS. 1A, 1B, and 1C are examples of header information for data packets that may be used with the NAT system of FIG. 2.

FIG. 2 is an exemplary block diagram of a NAT system.

FIG. 3 is an exemplary NAT table that may be used in the system of FIG. 2.

FIG. 4 is an exemplary procedure that may be used in the NAT system of FIG. 2.

Like reference symbols in the various drawings indicate like elements.

### DETAILED DESCRIPTION

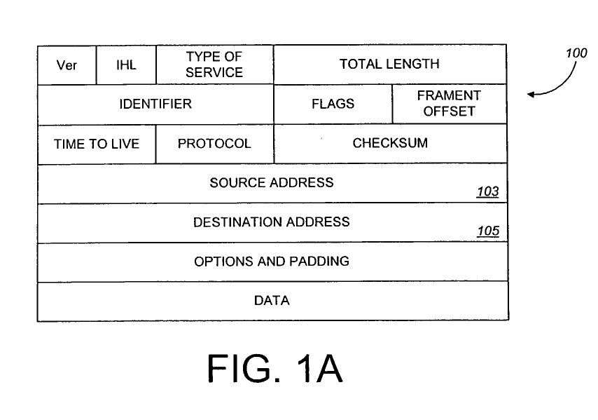

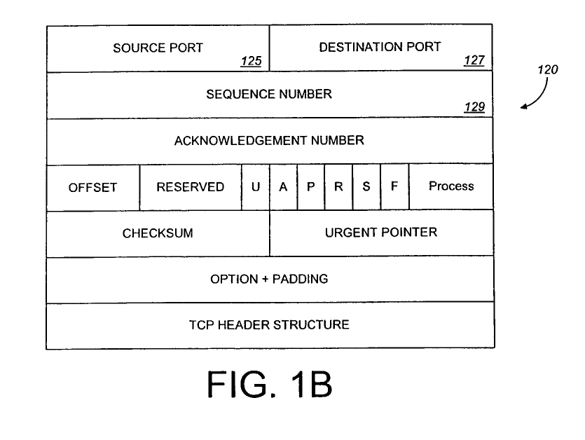

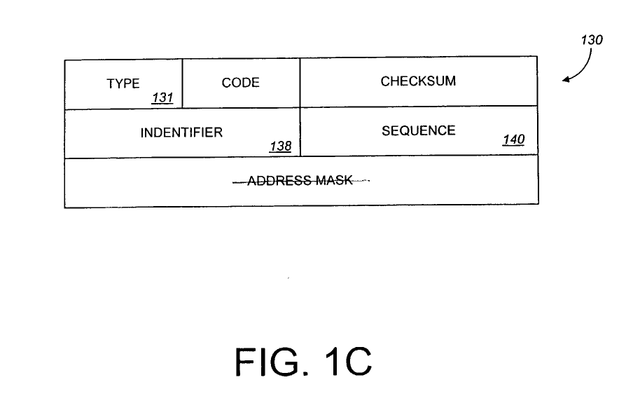

In general, packet headers may be used to route data packets through a packet switched network. For example, as shown in FIG. 1A, an IP header 100 includes fields for a source IP address 103 and a destination IP address 105. The source IP address field 103 indicates the host sending the packet, and the destination IP address field 105 indicates the host to which the packet is directed. As shown in FIG. 1B, the TCP header 120 includes fields for a source port 125, a destination port 127, and a sequence number 129. The fields of the IP/TCP headers 100, 120 may be processed by a router to send data packets to a network destination.

Packets that do not use the IP/TCP protocol must be processed differently by the router. For example, ICMP packets, which may be used to test and to report network errors or determine network conditions (e.g., approximating network latency), include an ICMP header (which differs from a TCP header 120). As shown in FIG. 1C, the ICMP packet header 130 includes fields for a type 131, an identifier 138, and a sequence number 140. However, the ICMP header 130 does not include, for example, a source port field 125 or a destination port field 127.

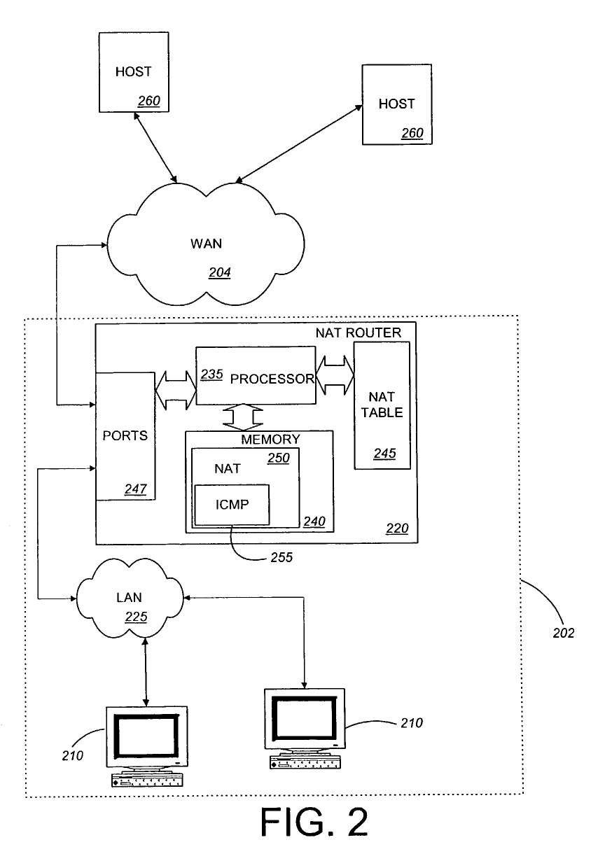

As shown in FIG. 2, an exemplary NAT system 200 may be used to route packets that include both IP/TCP headers 100, 120 and IP/ICMP headers 100, 130. The NAT system 200 may include a private network 202 connected to a public network 204 (e.g., a wide area network (WAN)). The private network 202 may include one or more hosts 210 connected to a NAT router 220 through a private local area network (LAN) 225. The public network 204 may connect one or more hosts 260. A host 210, 260 may be any intelligent device connected to a network, such as, for example, a processor, a computer, a workstation, a mainframe, a router, or a server. The private network 202 and the public network 204 shown in FIG. 2 are illustrative only and may include additional devices and systems.

The NAT router 220 manages flows of packets between the private network 202 and the public network 204. A flow is a sequence of packets that has the same source IP address and destination IP address, in addition to other characteristics, such as, for example, protocol and type of service. The NAT router 220 may include a processor 235, a memory 240, a NAT table 245, and one or more ports 247. The ports 247 may be connected to the private LAN 225 and the public network 204.

The memory 240 may store one or more applications, files, or programs, such as, for example, a NAT application 250 and an ICMP application 255. The memory may be implemented using a hard disk, a floppy disk, a compact disk, a non-volatile memory, a read only memory (ROM), a random access memory (RAM), or another device or medium capable of storing or providing instructions to a processor. Although the ICMP application 255 is shown as part of the NAT application 250 in FIG. 2, the applications may also be separate and distinct programs.

The processor 235 may process and route packets that are received on the ports 247. The processor 235 may be implemented using a programmable logic device (PLD), an application specific integrated circuit (ASIC), a digital signal processor (DSP) controller chip, or another device capable of processing and executing instructions. The processor 235 may access the memory 240 to execute instructions stored in the applications, files, and programs to process and route packets.

The NAT application 250 may include instructions that cause the processor 235 to translate packet IP addresses using the NAT table 245. If it is determined that an outgoing flow of packets is to be translated (i.e., the flow of packets includes a private source IP address directed to a host 260), then the processor 235 determines if there is an entry in the NAT table 245 that corresponds to a packet in the flow. If an entry is found, then the processor 235 inserts the global IP source address from the entry in the IP header 100 of the packet to replace the private source IP address. Similarly, if no entry is found, then the processor 235 selects a global IP address from one or more available global IP addresses stored in the NAT router 220, creates an entry in the NAT table 245 that includes the selected address as the global IP source address, and uses the selected address to replace the private source IP address. The packet is then routed to the public network 204 using one of the ports 247 specified by the processor 235.

The processor 235 also may translate the global destination IP address of a flow of packets received from an external host 260. To translate a received packet, the processor 235 searches the NAT table 245 for an entry that corresponds to the global IP address and inserts the corresponding private source IP address.

The processor 235 uses data obtained from packet headers to create entries and to search for entries in the NAT table 245. For example, when a IP/TCP packet that is to be translated is received at one of the ports 247 of the NAT router 220, the processor 235 determines header data of the packet, such as, for example, the source address, the destination address, the source port, the destination port, and the protocol of the packet. The processor 235 then searches the NAT table 245 for an entry that corresponds to the determined header data. If no corresponding entry is found, the processor 235 creates an entry using the determined header data.

The memory 240 also includes the ICMP application 255, which may include instructions that cause the processor 235 to translate ICMP packets. An ICMP packet may not be processed in the same manner as an IP/TCP packet because the ICMP packet header 130 does not include a source port field 125 or a destination port field 127. Before translating a packet, the processor 235 determines the protocol of the packet. If the processor 235 determines that the packet protocol is ICMP, then the processor 235 determines the identifier of the ICMP header 130.

The processor 235 uses the determined identifier to translate the packet. For example, the processor 235 stores the identifier in place of the source port and the destination port to create an entry in the NAT table 245. In addition, the processor 235 uses the identifier in place of the source port data and the destination port data to search the NAT table 245 for an entry that corresponds to the ICMP packet. In one implementation, the processor 235 may set port variables equal to the identifier to create entries and to search the NAT table 245.

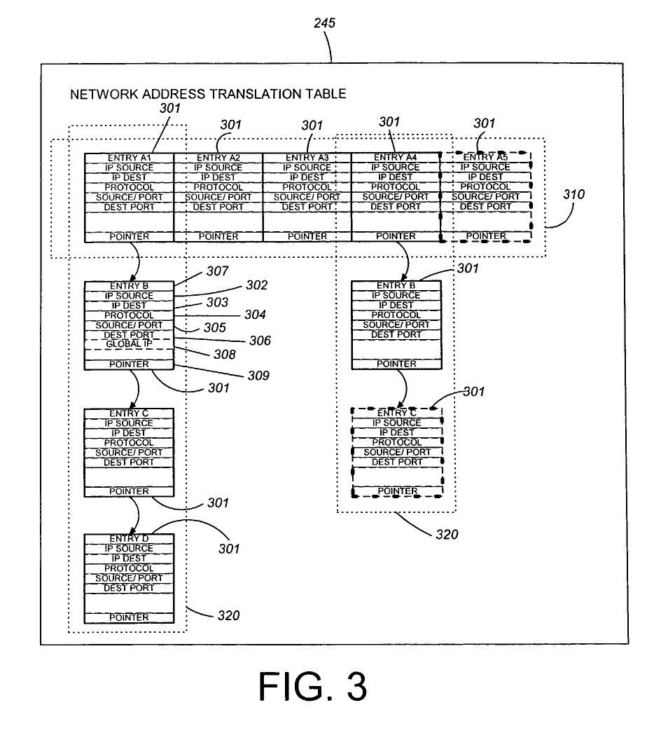

FIG. 3 is an example of a NAT table 245 that may be used with the NAT system 200 of FIG. 2. The NAT table 245 includes entries 301. The entries 301 are used by the processor 235 to translate packets. Each entry 301 may include data that is derived from packet headers and stored in one or more fields. For example, an entry 301 may include fields for the IP source address 302, the IP destination address 303, the protocol 304, the source port 305, and the destination port 306 of a packet. The entry also may include non-packet data, such as a name 307, a corresponding global IP address 308, and a pointer 309.

The entries 301 may be associated so as to provide faster searching of the NAT table 245. For example, the NAT table 245 may include a root array 310 of one or more entries 301 (e.g., A1, A2, A3, and A4). Each entry 301 in the root array 310 may have a different IP address and protocol. Entries 301 that have the same IP address and protocol may be grouped together to form a linked list 320 (e.g., A1, B1, C1, and D1).

According to the example shown in FIG. 3, if NAT is to be performed on a packet, the processor 235 searches the root array 310 for a corresponding entry. For example, if the packet is an outbound packet, then the processor 235 may determine if any of the entries 301 in the root array 310 have the same IP source address and protocol as the outbound packet. If none of the entries 301 (e.g., A1-A4) correspond to the packet, then the processor 235 creates a new entry (e.g., A5) for the outbound packet.

If one of the entries 301 (e.g., A4) corresponds to the packet, then the processor 235 may search the linked list 320 (e.g., A4, B4, C4) for an entry having data in common with the headers of the packet (e.g., an entry including the same IP source address, IP destination address, protocol, source port, and destination port). If a match is found in the linked list 320 (e.g., B4), then the processor 235 translates the packet using the global IP address stored in the entry 301. If no match is found in the linked list 320, then the processor 235 creates a new entry (e.g., C4) for the packet.

If the packet to be translated is determined to be an ICMP packet, then the processor 235 determines the appropriate IP address (e.g., the source IP address for outbound ICMP packets) and protocol, and searches the root array 310 for a corresponding entry 301. If a corresponding entry is found, then the processor 235 uses the identifier to search the linked list 320 and to determine if a match is found. The processor 235 uses the identifier from the identifier field 138 of the ICMP header 130 when searching the source port field 305 and the destination port field 306.

If no entry 301 in the root array 310 corresponds to the packet, then the processor 235 uses the data from the IP header 100 and ICMP header 130 to create an entry 301 in the NAT table 245. Processor 235 uses the identifier from the identifier field 138 of the ICMP header 130 when storing data in the source port field 305 and the destination port field 306 of an entry 301 that is created for an ICMP packet.

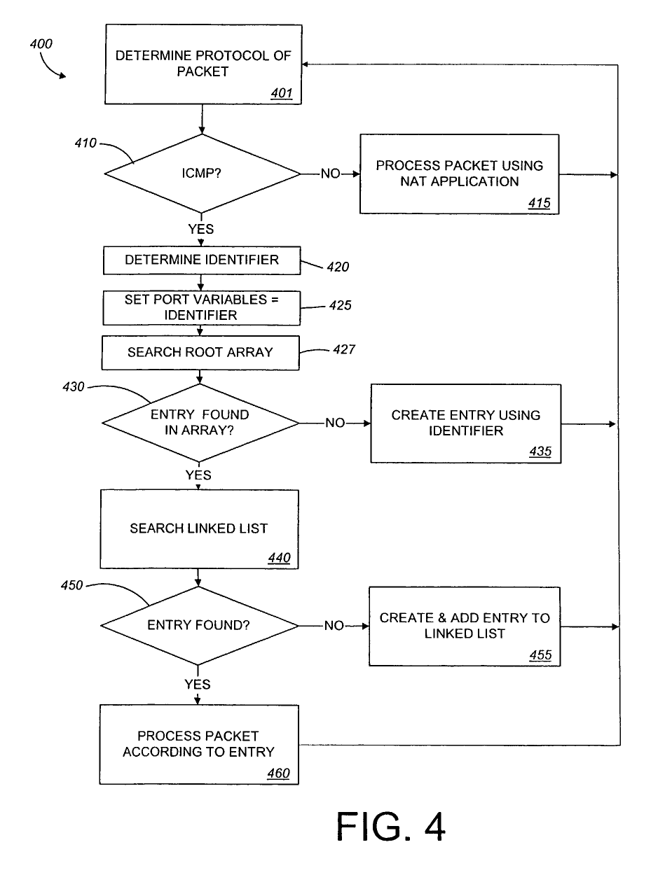

FIG. 4 illustrates a procedure 400 that may be used by the NAT system 200 of FIG. 2 to process ICMP packets. After determining that NAT is to be performed on a packet, the processor 235 determines the protocol of the packet from the packet IP header 100 (401). The processor 235 then determines if the packet protocol is ICMP (410). If the protocol is not ICMP, then the processor 235 processes the packet according to the NAT application 250 (415).

If the protocol is ICMP, then the processor 235 determines the identifier from the identifier field 138 of the ICMP header 130 (420). To translate the packet, the processor 235 sets a source port data variable and a destination port data variable equal to the ICMP identifier (425).

The processor 235 then searches the root array 310 of the NAT table 245 (427) and determines if there is an entry 301 that corresponds to the ICMP packet (430). If no entry 301 is found, the processor 235 creates an entry 301 in the NAT table 245 for ICMP packet (435). For example, the processor 235 may create an entry 301 by selecting a global IP address and storing the global IP address with data from the ICMP packet header 130 in the fields of the entry. The source port and the destination port variables are used to store the data in the source port field 305 and the destination port field 306. Since the source port variable and the destination port variable are equal to the ICMP packet identifier, the identifier is stored in the source port field 305 and the destination port field 306.

If an entry 301 that corresponds to the ICMP packet is found in the root array 310, then the processor 235 searches the linked list 320 for a matching entry 301 (440) and determines if there is an entry 301 in the linked list 320 that matches the ICMP packet (450). The processor 235 uses the source port variable and the destination port variable to search entries 301 in the linked list 320. Since the source port variable and the destination port variable are equal to the ICMP packet identifier, the processor 235 uses the ICMP packet identifier to determine if the data stored in source port field 305 and the destination port field 306 of an entry are a match.

If no entry 301 is found in the linked list 320 (450) the processor 235 creates a new entry 301 and adds the new entry to the linked list 320 using the pointer field 309 in the last entry in the list (455). If an entry corresponding to the packet is found, then the processor 235 translates the ICMP packet according to the data stored in the entry (460).

Using the identifier to create NAT entries for ICMP packets may reduce the number of entries that are stored in the NAT table. As a result, the amount of time needed to search the NAT table and to locate a relevant entry is reduced. Therefore, overall NAT processing efficiency is increased. Similarly, the memory required for storing entries in the NAT table may be reduced and/or overflow of entries in the NAT table may be eliminated or dramatically reduced.

A number of exemplary implementations have been described. Nevertheless, it will be understood that various modifications may be made. For example, advantageous results still may be achieved if the steps of the disclosed techniques are performed in a different order and/or if components in a disclosed architecture, system, device, or circuit are combined in a different manner and/or replaced or supplemented by other components. Accordingly, other implementations are within the scope of the following claims.

What is claimed is:

1. A router comprising:
one or more ports configured to receive and to transmit packets; and
a processor to identify Internet control message protocol (ICMP) packets received by the one or more ports, each ICMP packet including an ICMP header having an identifier, and to translate addresses of the ICMP packets using the identifier.

2. The router of claim 1 further comprising a table to store entries that include data about packet flows, wherein the processor is configured to create entries in the table and to search for entries in the table to translate addresses of the ICMP packets.

3. The router of claim 2 wherein:
the data stored in an entry for a packet flow includes a source port data field, and
the processor is configured to store the identifier in the source port data field of an entry created for an identified ICMP packet.

4. The router of claim 2 wherein:
the data stored in an entry for a packet flow includes a destination port data field, and
the processor is configured to store the identifier in the destination port data field of an entry created for an identified ICMP packet.

5. The router of claim 2 wherein:
the data stored in an entry for a packet flow includes a source port data field and a destination port data field, and
the processor is configured to store the identifier in the source port data field and the destination port data field of an entry created for an identified ICMP packet.

6. The router of claim 2 wherein the processor is configured to use the identifier to search entries in the table for an identified ICMP packet.

7. The router of claim 3 wherein the processor is configured to set a source port variable equal to the identifier and to store the source port variable in the source port field.

8. The router of claim 4 wherein the processor is configured to set a destination port variable equal to the identifier and to store the destination port variable in the destination port field.

9. The router of claim 5 wherein the processor is configured to set a source port variable and a destination port variable equal to the identifier, to store the source port variable in the source port field, and to store the destination port variable in the destination port field.

10. A system comprising:
an external network;
a private network;
a host communicating with the private network, having a private network address, and configured to transmit one or more Internet control message protocol (ICMP) packets that include headers, with each header having a private network address and an identifier;
a router communicating with the external network and the private network, to process the one or more ICMP packets and to translate the private network address of the one or more ICMP packets, and including a processor configured to use the identifier to translate the private network address.

11. The system of 10 wherein:
the router further includes a table to store entries that include data about packet flows, and
the processor is configured to create entries in the table and to search for entries in the table to translate addresses of the ICMP packets.

12. The system of 11 wherein:
the data stored in an entry for a packet flow includes a source port data field, and
the processor is configured to store the identifier in the source port data field of an entry created for an identified ICMP packet.

13. The system of claim 11 wherein:
the data stored in an entry for a packet flow includes a destination port data field, and
the processor is configured to store the identifier in the destination port data field of an entry created for an identified ICMP packet.

14. The system of claim 11 wherein:
the data stored in an entry for a packet flow includes a source port data field and a destination port data field, and
the processor is configured to store the identifier in the source port data field and the destination port data field of an entry created for an identified ICMP packet.

15. The system of claim 11 wherein the processor is configured to use the identifier to search entries in the table for an identified ICMP packet.

16. The system of claim 12 wherein the processor is configured to set a source port variable equal to the identifier and to store the source port variable in the source port field.

17. The system of claim 13 wherein the processor is configured to set a destination port variable equal to the identifier and to store the destination port variable in the destination port field.

18. The system of claim 14 wherein the processor is configured to set a source port variable and a destination port variable equal to the identifier, to store the source port variable in the source port field, and to store the destination port variable in the destination port field.

19. A method of performing network address translation (NAT), the method comprising:
receiving a packet including a protocol;
determining the protocol of the packet;
determining that the protocol is an Internet control message protocol (ICMP);
determining an identifier of an ICMP header of the packet; and
translating the packet using the identifier.

20. The method of claim 19 wherein translating the packet includes creating an entry in a NAT table using the identifier.

21. The method of claim 20 wherein creating the entry includes storing the identifier in the entry.

22. The method of claim 19 wherein translating the packet includes:
setting a port variable for a source port equal to the identifier; and
creating an entry in a NAT table using the port variable.

23. The method of claim 19 wherein translating the packet includes:
setting a port variable for the destination port equal to the identifier; and
creating an entry in a NAT table using the port variable.

24. The method of claim 19 wherein translating the packet includes searching for an entry in a NAT table using the identifier.

25. The method of claim 24 wherein searching for the entry includes determining if the identifier matches data stored in an entry stored of the NAT table.

26. The method of claim 19 wherein translating the packet includes:
setting a port variable for a source port equal to the identifier; and
searching for an entry in a NAT table that includes the port variable.

27. The method of claim 19 wherein translating the packet includes:
setting a port variable for a destination port equal to the identifier; and
searching for an entry including the port variable in a NAT table that includes the port variable.

28. A computer readable medium including instructions for causing a processor to:
determine a protocol of a packet;
determine that the protocol is an Internet control message protocol (ICMP);
determine an identifier of an ICMP header of the packet; and
translate the packet using the identifier.

29. The computer readable medium of claim 28 wherein the instructions to translate the packet include instructions that cause a processor to create an entry in a NAT table using the identifier.

30. The computer readable medium of claim 28 wherein instructions to create the entry include instructions that cause a processor to store the identifier in the entry.

31. The computer readable medium of claim 28 wherein the instructions to translate the packet include instructions that cause a processor to:
set a port variable for a source port equal to the identifier; and
create an entry in a NAT table using the port variable.

32. The computer readable medium of claim 28 wherein the instructions to translate the packet include instructions that cause a processor to:
set a port variable for the destination port equal to the identifier; and
create an entry in a NAT table using the port variable.

33. The computer readable medium of claim 28 wherein the instructions to translate the packet include instructions that cause a processor to search for an entry in a NAT table using the identifier.

34. The computer readable medium of claim 28 wherein instructions to search for the entry include instructions that cause a processor to determine if the identifier matches data store in an entry of the NAT table.

35. The computer readable medium of claim 28 wherein instructions to translate the packet include instructions that cause a processor to:
set a port variable for a source port equal to the identifier; and
search for an entry in a NAT table that includes the port variable.

36. The computer readable medium of claim 28 wherein the instructions to translate the packet include instructions that cause a processor to:
set a port variable for a destination port equal to the identifier; and
search for an entry including the port variable in a NAT table that includes the port variable.
